(19) United States
(12) Patent Application Publication
(10) Pub. No.: US 2014/0242567 A1
(43) Pub. Date: Aug. 28, 2014

(54) Underlying Student Test Error Detection System and Method

(71) Applicant: Janua Educational Services, LLC, Rowland Heights, CA (US)

(72) Inventor: SEEOEN LEE, Daejeon (KR)

(21) Appl. No.: 14/191,860

(22) Filed: Feb. 27, 2014

Related U.S. Application Data
(60) Provisional application No. 61/891,917, filed on Oct. 17, 2013.
(60) Provisional application No. 61/770,288, filed on Feb. 27, 2013.

(51) Int. Cl. G09B 7/06

(52) U.S. Cl. CPC G09B 7/06
USPC 434/362

(57) ABSTRACT

A system for improving a student's knowledge or problem solving skills that identifies errors of a student's understanding of an underlying topic or application of a requisite skill needed to answer a test question correctly. The system includes a computer with a testing software program that presents a set of two or more questions regarding a topic to a student. Associated to the topic is a set of core concepts. Each question is associated with one or more core concepts and related with the other questions so that at least one core concept matches the core concept on the other questions. When the student incorrectly answers a question, the core concepts associated with the question is reviewed and the answers to the questions containing the matching core concepts are reviewed. If a question associated with the common core concept is previously answered correctly, the core concept associated exclusively to the question answered incorrectly is deemed the source of the error. Instructional materials associated with the core concept deemed to the source of the error are provided to the student.

This utility patent application is based upon and claims the filing date benefits of U.S. provisional patent application (Application No. 61/891,917) filed on Oct. 17, 2013 and U.S. provisional patent application (Application No. 61/770,288) filed on Feb. 27, 2013.

### COPYRIGHT NOTICE

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

The present invention relates to testing systems for evaluating a student's understanding of an educational topic, and more particularly, to such systems that help a student identify a misunderstood underlying concept or related topics associated with the education topic which caused an incorrect answer on a test.

2. Description of the Related Art

Students in a grade are taught subjects that are built on what they learned in the previous grade. For example, schools_often teach addition and subtraction in the second grade, multiplication and division in the third grade, and fractions and decimals in the fourth grade. In the fifth grade, students must solve more complex problems that require they apply a combination of math skills to solve a problem.

When students are tested in school, they usually receive a final test score informing them of the correct and incorrect answers. Usually, the final test scores tells the teacher and the student whether the student understands the test topic. Because complex problems require students to apply a combination of math skills to solve a problem, when students incorrectly answer a complex problem, it is important to identify the underlying cause or source of the error. For example, if the problem was “⅙+⅓=X”, which the student answered incorrectly as “⅚”, was the incorrect answer caused by the student's failure to convert the fractions to a common denominator (i.e “⅙=⅔”) or was it a simple addition error (i.e “⅙+ 2/6= 4/6”)?

What is needed is a system that tests a student's knowledge of an educational topic and when an incorrect answer is provided, identifies the cause or source of the error and then provides teaching materials or instructions regarding the source of the error so it may be eliminated.

### SUMMARY OF THE INVENTION

Disclosed herein is a self learning correction method and system that identifies problem areas in a student's knowledge or understanding of an educational topic or subject. Understanding an educational topic or subject depends on the student's understanding underlying facts, assumptions, and relationships and specific tasks that must be followed in a particular order. In the invention described herein, these are known as ‘core concepts’ of the topic. If the student fails to core concepts, the student's test answers may be incorrect.

In the system and method described herein a computer and a computer testing program that presents a set of test questions pertaining to a topic. Each test question is associated or requires application of one or more core concepts associated with the topic. The test questions are also related so their core concepts match or overlapped at least once in the set of questions. For example, Question 1 may pertain to core concept A, Question 2 pertains to core concepts A and B, and Question 3 pertains to core concepts B and C.

After all of the test questions have been answered by the student, the system is designed to detect correct and incorrect answers. When an incorrect answer is detected, system identifies the core concepts associated with the question and one or more questions (called a reference question) in the set of questions also associated with at least one common core concept. If the reference question is answered correct, then the system assumes that the student understands the common core concept and the uncommon core concept is deemed the source of the error. If more than one question is answered incorrectly, then the common core concept may be deemed the source of the error. Sometimes, several reference questions are reviewed to identify core concepts deemed understood and core concepts deemed misunderstood. Instructional materials associated with the core concept deemed to the source of the error are provided to the student.

Using the above described system a method for identifying the misunderstanding of a core concept associated with a topic is disclosed.

### DESCRIPTION OF THE DRAWINGS

FIG. 1 is an illustration of the self learning system that enables a student to identify misunderstandings of underlying core concepts of an educational topic or subject and then provides teaching materials to the student regarding the identified core concept.

FIG. 2 is an illustration of a class room environment in which a plurality of students take a test using the system.

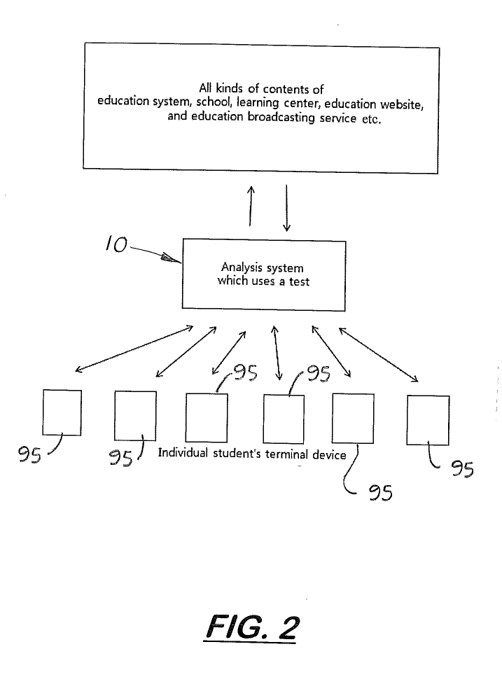

FIG. 3 is an illustration of an electronic device with a set up questions pertaining to 5th grade math.

FIG. 4 is an illustration depicting the core concepts associated with each question presented to the student on the electronic display shown in FIG. 3.

FIG. 5 is a graphic representation showing how the questions answered correctly are used as reference questions to determine which core concepts caused an incorrect answer.

FIG. 6 is a flow chart showing the method for identifying the misunderstanding of a core concept associated with a topic.

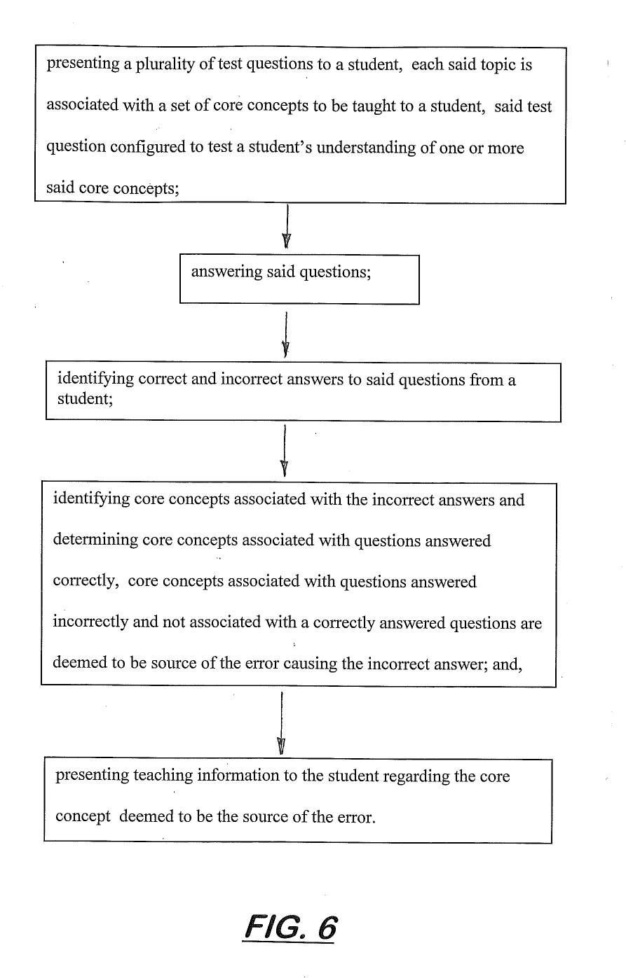

### DESCRIPTION OF THE PREFERRED EMBODIMENT(S)

Referring to the accompanying Figs. there is shown a self learning system 10 that identifies problem areas in a student's knowledge or understanding of an educational topic or subject. Understanding an educational topic or subject depends on the student's understanding underlying facts, assumptions, and relationships and specific tasks that must be followed in a order. In the invention described herein, these are known as ‘core concepts’ of the topic. If the student 95 does not understand or fails to apply a core concept, the student's test answers may be incorrect.

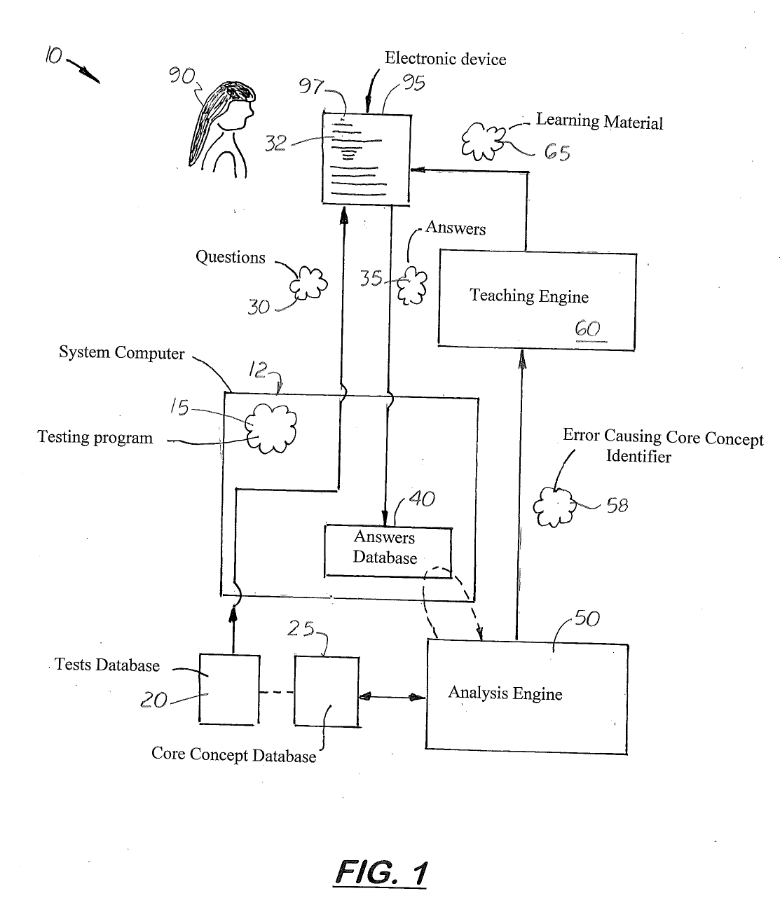

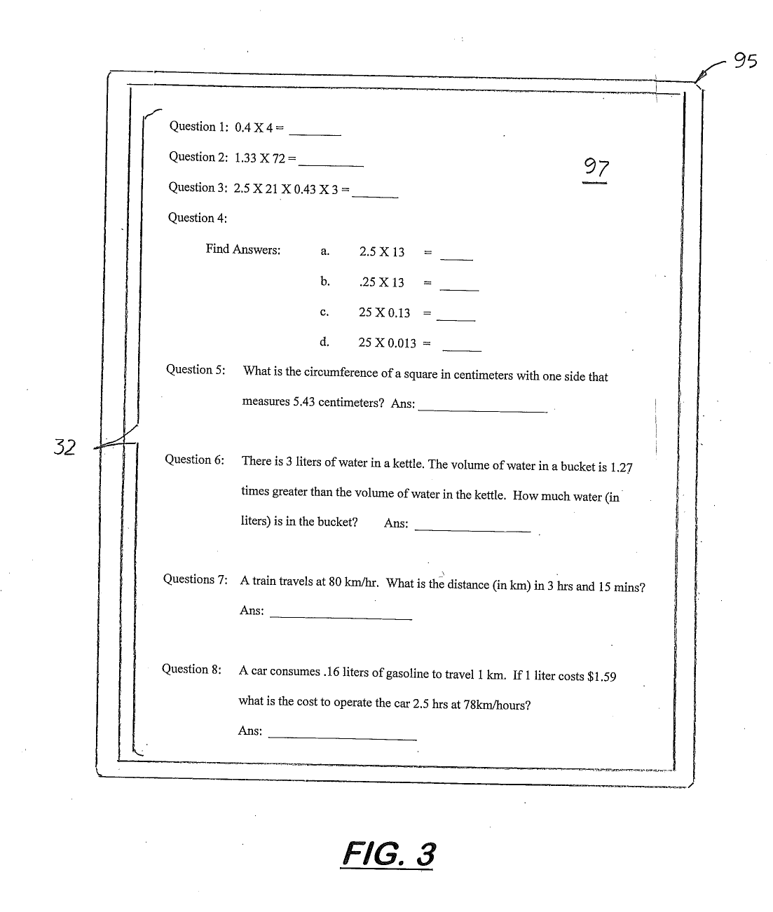

In the system 10, a system computer 12 is used with working memory. Loaded in the working memory is a software testing program 15 that presents a set of test questions 30 pertaining to a topic to an electronic device 95 operated by a student 95. The system computer 12 is connected or linked to a tests database 20. The tests database 20 is linked to a core concept database 25. The Questions 30 are stored in the test database 20 and delivered to the display 97 on the electronic device. A set of questions 32 are presented on the display 97 as shown in FIGS. 1 and 3. Each Question 30 is associated or requires knowledge or application of one or more core concepts 55 associated with the Question. The core concepts 55 may be stores in the test database 20 or stored in a separate core concept database 25.

When a test is taken, the answers 35 are imputed by the student 90 onto a keyboard or on the display 97 and transmitted to an answer database 40. An analysis engine 50 then reviews the answers 35 to determine if they are correct or incorrect. When an incorrect answer 35 is detected, the analysis engine 50 identifies the core concepts 55 associated with the question 35 and one or more questions (called reference questions 35′) in the set of questions 32 also associated with at least one core concept common to the question answered incorrectly. If the reference question 35′ is answered correct, then the system 10 assumes that the student understands the common core concept 55 and the uncommon core concept 55′ is deemed the source of the error. If more than one Question is answered incorrectly, then the common core concepts 55′ associated with the Questions is deemed the source of the error. Sometimes, several reference questions must be reviewed to identify core concepts deemed understood and core concepts deemed misunderstood.

After the misunderstood or non-utilized core concept 55′ has been identified, the analysis engine 50 then transmits the error causing core concept identifier 58 to the teaching engine 60. The teaching engine 60 then prepares learning materials 65 for the error causing core concept 55 to the student 90 on the electronic device. 95.

Using the above described system a method for identifying the misunderstanding of a core concept associated with a topic, comprising the following steps:

a. presenting a plurality of test questions to a student on one screen or one by one through multiple screens, each said topic is associated with a set of core concepts to be taught to a student, said test question configured to test a student's understanding of one or more said core concepts;

b. answering said questions;

c. identifying correct and incorrect answers to said questions from a student;

d. identifying core concepts associated with the incorrect answers and determining core concepts associated with questions answered correctly, core concepts associated with questions answered incorrectly and not associated with a correctly answered questions are deemed source of the error causing the incorrect answer; and,

e. presenting teaching information to the student regarding the core concept deemed the source of the error.

### EXAMPLE

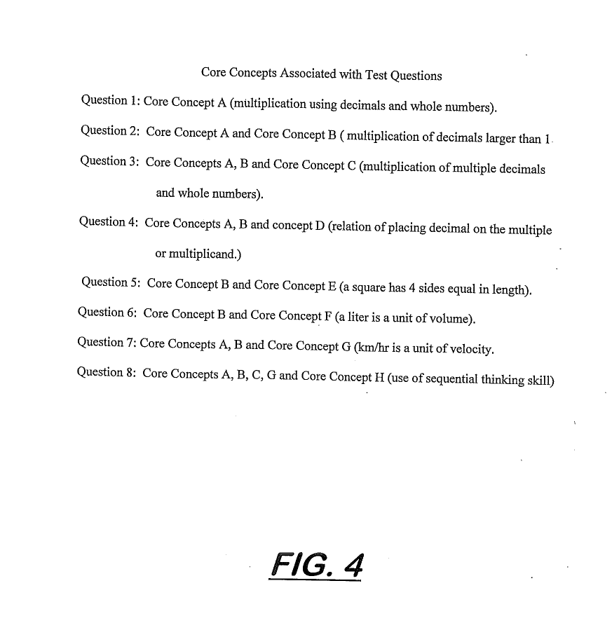

FIG. 3 is an illustration of an electronic device 10 with a set of questions 30 pertaining to 5th grade math topic which answered by a student using the system 10. Assume that the analysis engine 50 reviews the answers 35 and determines that Questions 1, 2, 3 4, 7, and 8 were answered correctly and Questions 5 and 6 were answered incorrectly. The analysis engine 50 then determines that correctly answered Questions 1, 2, 3, 4, 7 and 8 are associated with core concepts A, B, C, D, G and H as listed in FIG. 4. The analysis engine 50 assumes the student 90 understands the core concepts A, B, C, D, G, and H and thereby reviews the core concepts associated with the Questions 5 and 6.

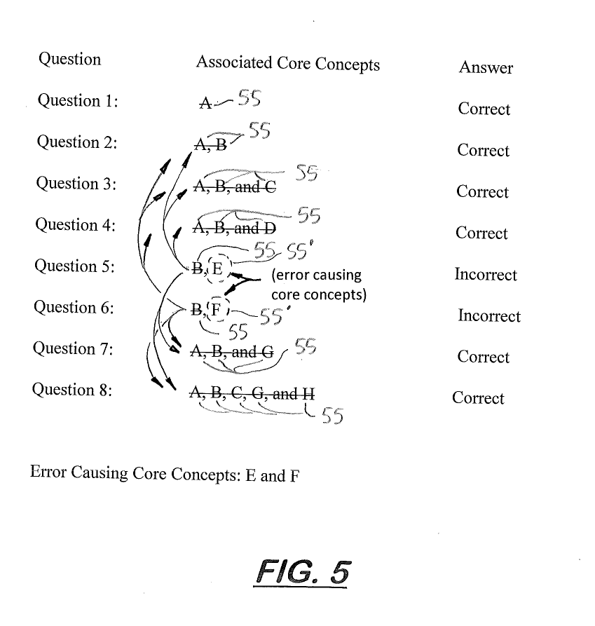

As shown in FIG. 5, Question 5 is associated with core concepts B and E and Question 6 is associated with core concepts B and F. Because Questions 1 and 2 were answered correctly and associated with core concepts A and B, the analysis engine 50 assumes that the student's lack or failure to understand the core concept E was the source of the error that caused Question 5 to be Incorrectly answered. Because Questions 6 is also associated with core concept B, the analysis engine 50 assumes that the student's lack of knowledge of core concept F was the source of the error that caused Question 6 to be answered incorrectly. FIG. 5 shows how the analysis engine 50 uses a process of elimination of the core concepts 55 associated with the test questions to determine the error causing core concepts 55 that need to be reviewed.

An error causing core concept identifiers 58 associated with error causing core concepts E and F are then sent to the Teaching Engine 60. The Teaching Engine 60 then transmits L earning Materials 65 for the core concepts E and F to the student 90.

It should be understood, that the electronic device 95 may be a tablet computer, a desktop computer, a laptop computer, a dumb terminal, or a smart phone. It should also be understood that the system computer 12 may be connected to the electronic device 95 may be wired or wirelessly connected to the system computer 12. Also, the testing program 15 may also be loaded into the working memory of the electronic device 95 and receive a set of questions 30 from a remotely located test database 20. And multiple questions can be provided at one time on one screen or one by one through different multiple screens. It should also be understood that the system's computer 12, the analysis engine 50, the testing program 15 and teaching engine 60 may also be combined into a single unit.

In compliance with the statute, the invention described has been described in language more or less specific as to structural features. It should be understood, however, that the invention is not limited to the specific features shown, since the means and construction shown comprises the preferred embodiments for putting the invention into effect. The invention is therefore claimed in its forms or modifications within the legitimate and valid scope of the amended claims, appropriately interpreted under the doctrine of equivalents.

I claim:

1. A system for improving a student's knowledge or problem solving skills, comprising:
a. a computer with working memory;
b. a software testing program loaded into the working memory in the computer, said test program configured to present a set of test questions regarding a particular topic to a student, each said topic is associated with a set of core concepts to be taught to a student, said test question configured to test a student's understanding of one or more said core concepts, said testing program configured to identified correct and incorrect answers to said questions from a student, questions with incorrect answers are reviewed to determine said core concepts associated therewith, said core concepts associated with questions answered correctly are ignored, and core concepts associated with questions answered incorrectly and not associated with a correctly answered questions are deemed to be source of the error causing the incorrect answer; and,
c. a learning engine that presents teaching information regarding the core concept deemed to be the source of the error.

2. The system as recited in claim 1, further including an electronic device coupled or linked to said computer and operated by a student.

3. The method for identifying the misunderstanding of a core concept associated with a topic, comprising the following steps:
a. presenting a plurality of test questions to a student, each said topic is associated with a set of core concepts to be taught to a student, said test question configured to test a student's understanding of one or more said core concepts;
b. answering said questions;
c. identifying correct and incorrect answers to said questions from a student;
d. identifying core concepts associated with the incorrect answers and determining core concepts associated with questions answered correctly, core concepts associated with questions answered incorrectly and not associated with a correctly answered questions are deemed to be source of the error causing the incorrect answer; and,
e. presenting teaching information to the student regarding the core concept deemed to be the source of the error.
